(19) United States
(12) Patent Application Publication
(10) Pub. No.: US 2016/0075422 A1
(43) Pub. Date: Mar. 17, 2016

(54) SYSTEM AND METHOD FOR GAS AND, OPTIONALLY, LIQUID CARGO TRANSPORTATION BY AIR

(71) Applicant: Leonid Goldstein, Austin, TX (US)

(72) Inventor: Leonid Goldstein, Austin, TX (US)

(21) Appl. No.: 14/833,159

(22) Filed: Aug. 24, 2015

Related U.S. Application Data
(60) Provisional application No. 62/050,168, filed on Sep. 14, 2014.
(60) Provisional application No. 62/091,022, filed on Dec. 12, 2014.
(60) Provisional application No. 62/095,751, filed on Dec. 22, 2014.
(60) Provisional application No. 62/135,695, filed on Mar. 19, 2015.

(51) Int. Cl. B64B 1/00; B64B 1/70

(52) U.S. Cl. CPC B64B 1/00; B64B 1/70

(57) ABSTRACT

A system and a method for gas transportation by air, in which the transported gas also creates at least some of the lift for the airship, transporting it. In the same time, a fluid cargo, which also serves as ballast, is loaded. One of the options is that some of the transported gas is carried in a compressed form within a strong vessel on the airship. Among other options for the fluid cargo is the same gas in liquefied form, sea water, fresh or brackish water, LPG and oil. Yet another option is carrying easily liquefied gas, which is evaporated and fills in the airship envelope on its way back. Other embodiments are disclosed, such as cooling the transported gas or using heated air or steam when the transported gas is unloaded. A network of airships, terminals and control stations for natural gas transportation by air and more can be used with multiple airships of this kind.

### CROSS REFERENCE TO RELATED APPLICATIONS

This Application claims the benefit of priority of the U.S. Provisional Applications No. 62/050,168, filed 14 Sep. 2014, No. 62/091,022, filed 12 Dec. 2014, No. 62/ 095,751, filed 22 Dec. 2014, and No. 62/ 135,695, filed 19 Mar. 2015, by the same inventor as herein, the entire disclosure of which is incorporated herein by reference.

### BACKGROUND OF THE INVENTION

The invention is generally directed to a system and a method for gas transportation by air.

U.S. Pat. No. 3,488,019 by Sonstegaard discusses a cargo-gas airship with boundary layer control, using ballast tanks carrying liquid ballast.

U.S. Pat. No. 3,844,507 and 3,456,903 by Papst discuss airships for transportation of impellent gases, in which the “cavity” is filled with hot air or steam or their mixture on its way back.

U.S. Pat. No. 3,706,433 by Milne discusses a dirigible with collapsible chambers for gas transportation.

U.S. Pat. No. 3,972,492 by Sonstegaard discusses a cargo-gas airship with boundary layer control, using ballast tanks carrying liquid ballast.

These patents date back to 1976 or earlier and do not address modern needs such as safety, material economy, and high cost of ground infrastructure. The methods and systems according to these patents were not actually implemented and are not necessarily practical or even physically possible without additional inventive steps. Thus, there is an unfulfilled need for systems and methods of gas cargo transportation by air.

### SUMMARY OF THE INVENTION

The invention is directed to a system and a method for gas transportation by air.

There are many locations with available natural gas, which are not exploited because the cost of transportation exceeds the potential value of the gas.

One embodiment of the invention is a method of transporting a lighter than air gas, the method comprising: providing an unmanned steerable airship, comprising an envelope, a propulsion means and an automatic control system, having a plurality of sensors and a plurality of microprocessors; at a first location, loading the transported gas into the envelope of the airship; flying the airship from the first location to a second location, using the automatic control system; at the second location, unloading at least most of the transported gas from the airship.

Additional steps may include, in various combinations: at the first location, additionally loading a cargo fluid onto the airship; at the second location, unloading the cargo fluid from the airship; permanently carrying a predefined amount of hydrogen or helium on the airship; the transported gas providing at least half of the buoyancy of the airship when the airship flies from the first location to the second location. The transported gas can be natural gas. The cargo fluid can contain water or additional amount of the natural gas under above atmospheric pressure (i.e. at least 10 bar) or additional amount of the natural gas in liquid form or liquid hydrocarbons, selected from the group consisting of ethane, propane, butane and pentane.

Another embodiment of the invention is an airship for transporting gas, the airship comprising: an envelope; a propulsion means; an automatic control system for unmanned flight, the automatic control system having a plurality of sensors, a plurality of microprocessors; a first variable volume compartment within the envelope for the transported gas; a second variable volume compartment within the envelope for air; a vessel for a fluid which serves as a ballast; wherein at least half of the vehicle buoyancy is created by the transported gas.

The transported gas may be natural gas. The first and/or second variable volume compartment may be a bag. The vessel may be a pressure vessel, capable of withstanding internal pressure substantially above the atmospheric pressure. The vessel may contain additional amount of the transported gas, compressed substantially above the atmospheric pressure. The airship may further comprise a compressor, adapted to compress some of the transported gas from the first variable volume compartment and to move it into the vessel. The vessel may contain hydrocarbon fluids at above atmospheric pressure and at least some of the hydrocarbon fluids may be in liquid phase. Alternatively, the vessel may contain water. The airship may be equipped with a probe for transfer of the transported gas between the airship and ground installations.

Some of embodiments and variations of the invention are summarily described below in the following articles:

A1. A method of transporting a gas, the method comprising:
providing an unmanned steerable airship, comprising an envelope, a propulsion means and an automatic control system;
at a first location, loading the transported gas into the envelope of the airship;
flying the airship from the first location to a second location, using the automatic control system;
at the second location, unloading at least most of the transported gas from the airship.

A2. The method of Article A1, further comprising:
at the first location, loading a cargo fluid onto the airship;
at the second location, unloading the cargo fluid from the airship.
A3. The method of any of Articles A1-A2, wherein the airship permanently carries a predefined amount of a light gas, having density less than the transported gas.

A4. The method of any of Articles A1-A3, wherein the transported gas provides at least half of the buoyancy of the airship when the airship flies from the first location to the second location.

A5. The method of any of Articles A1-A4, wherein the transported gas is natural gas.

A6. The method of any of Articles A2-A5, wherein the light gas is hydrogen.

A7. The method of any of Articles A2-A6, wherein the cargo fluid contains an additional amount of the transported gas under above atmospheric pressure.

A8. The method of any of Article 8, wherein the additional amount of the transported gas is under pressure of at least 10 bar.

A9. The method of any of Articles A2-A6, wherein the cargo fluid contains an additional amount of the transported gas in a liquid phase.

A10. The method of any of Articles A2-A6, wherein the cargo fluid contains liquid hydrocarbons, having molecules with 2 or more carbon atoms.

A11. The method of any of Articles A2-A6, wherein the cargo fluid is water.

A12. The method of Article 11, wherein the unloaded water is used for industrial purposes.

A13. The method of Article 11, wherein the unloaded water is disposed of.

B1. An airship for transporting gas, the airship comprising:
an envelope;
a propulsion means;
an automatic control system for unmanned flight;
a first variable volume compartment within the envelope for the transported gas;
a second variable volume compartment within the envelope for air;
a vessel for a fluid which serves as a ballast;
wherein at least half of the vehicle buoyancy is created by the transported gas.

B2. The airship of Article B1, further comprising a fixed volume compartment for a light gas, lighter than the transported gas.

B3. The airship of any of Articles B1-B2, wherein the light gas is hydrogen.

B4. The airship of any of Articles B1-B2, wherein the light gas is helium.

B5. The airship of any of Articles Article B1-B4, wherein the transported gas is natural gas.

B6. The vehicle of any of Articles B1-B5, wherein the first variable volume compartment is a bag.

B7. The vehicle of any of Articles B1-B6, wherein the second variable volume compartment is a bag.

B8. The airship of any of Articles B1-B7, wherein the vessel is a pressure vessel, capable of withstanding internal pressure substantially above the atmospheric pressure.

B9. The airship of Article B8, wherein the vessel contains the transported gas, compressed substantially above the atmospheric pressure.

B10. The airship of Article B9, further comprising a compressor, adapted to compress some of the transported gas from the first variable volume compartment and to move it into the vessel.

B11. The airship of Article B8, wherein the vessel contains hydrocarbon fluids at above atmospheric pressure and below ambient temperature and at least some of the hydrocarbon fluids are in liquid phase.

B12. The airship of any of Articles B1-B7, wherein the vessel is adapted to be filled with liquid under normal temperature and pressure.

B13. The airship of Article B12, wherein the vessel contains liquid hydrocarbons.

B14. The airship of Article B12, wherein the vessel contains water.

B15. The airship of any of Articles B1-B14, wherein the first variable volume compartment occupies most of the space inside of the envelope.

B16. The airship of any of Articles B1-B15, further comprising a probe for transfer of the transported gas between the airship and ground installations.

B17. The airship of any of Articles B1-B16, comprising plurality of the vessels.

B18. The airship of any of Articles B1-B17, comprising plurality of the first variable volume compartments.

B19. The airship of any of Articles B1-B18, comprising plurality of the second variable volume compartments.

B20. The airship of any of Articles B1-B19, comprising plurality of the second variable volume compartments.

B21. The airship of any of Articles B2-B20, comprising plurality of the fixed volume compartments.

B22. A gas transporting system, comprising the airship of any of Articles B1-B21 and ground means for loading or unloading the transported gas through the probe.

B23. A gas transporting system, comprising the airship of any of Articles B1-B22 and ground means for airship docking.

C1. A network for transporting natural gas, the network comprising:
at least one unmanned airship, designed for transporting natural gas;
at least one loading station, comprising means for the airship docking and means for natural gas loading;
at least one unloading station, comprising means for the airship docking and means for natural gas unloading;
at least one monitoring station, comprising means for remote control of the unmanned airship.

C2. The network of Article C1, wherein the loading station and the unloading station are at the distance between 5 kilometers and 500 kilometers.

The airship is unmanned and navigates mostly automatically with little monitoring or control from the ground. On short routes (like less than 500 km), the airship can make multiple round trips per day.

The term ‘natural gas’ encompasses natural gas from gas and oil wells, coal bed gas, natural gas from hydrates and other underground and underwater sources. The natural gas might have been subjected to processing, including dehydration, condensate removal, heavier hydrocarbons separation, nitrogen rejection, desulphurization, CO2 removal, odorant addition, prior liquefaction and regasification etc. Also, the term ‘natural gas’ includes methane.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1A shows a side cutout view of a “loaded” airship in one of the embodiments of the invention.

FIG. 1B shows a cross section in a plane, perpendicular to the long axis of the “loaded” airship.

FIG. 1C shows the same cross section of the “unloaded” airship.

FIG. 2 shows the airship docked at a ground station.

FIG. 3 shows an example flowchart of airship activity.

FIG. 4 shows schematically some of communication channels between various actors in one aspect of the invention.

FIG. 5 shows schematically the airship control system.

FIG. 6 shows an example of a gas transportation network according to another aspect of the invention.

FIG. 7A shows a simplified side view of an airship in another embodiment of the invention.

FIG. 7B shows a correspondent cross section in a plane, perpendicular to the long axis of the “unloaded” airship in this embodiment.

### DETAILED DESCRIPTION OF THE PREFERRED EMBODIMENTS

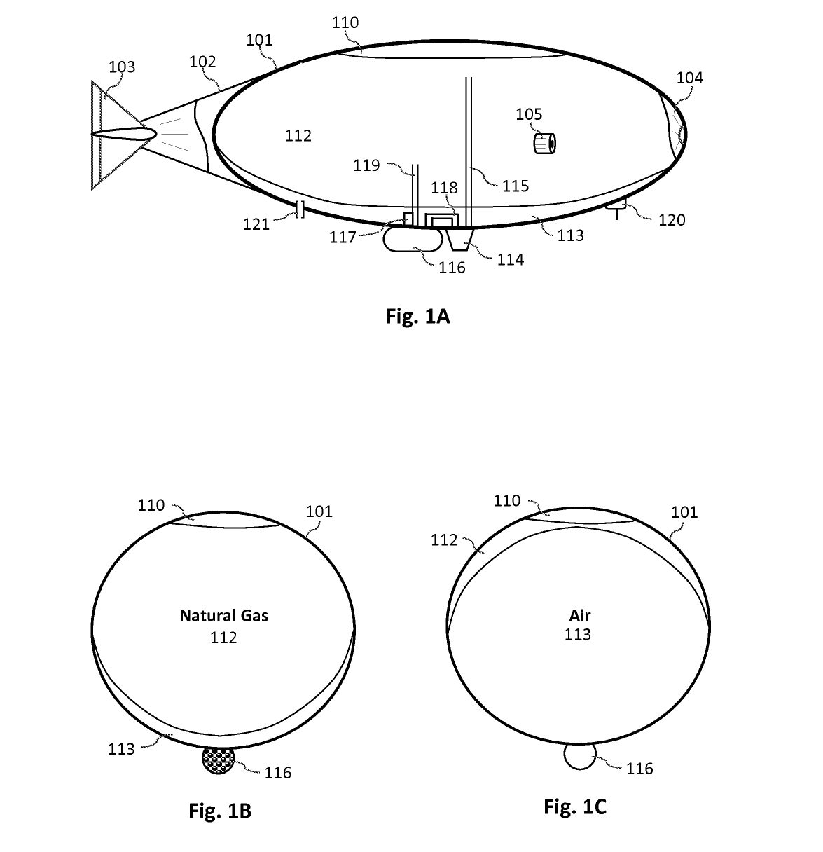

One of the embodiments of the invention is an airship for transporting gas, shown in FIG. 1A-FIG. 1C. FIG. 1A shows a side view with a cut of the airship, loaded with the transported gas.

The airship has a body, comprising a gas tight envelope 101 and a tail 102, connected in such a way that the body has an aerodynamically streamlined shape. There is an empennage 103 on tail 102, having horizontal and vertical stabilizers and horizontal and vertical rudders. There is a reinforced bow 104, which can comprise battens or ribs or rigid surfaces. The airship is equipped with propulsion means 105, which is preferably attached to the reinforced bow or a frame, if present. Propulsion means 105 may be one, two or multiple turboprop, turbofan or other type of internal combustion engines or even electrical motors. Rotary or reciprocating engines can be used with ducted or non-ducted propellers. The engines may utilize the transported gas as fuel, or use another onboard fuel source. Small thrusters can be installed for maneuvering. Inside envelope 101, there are an optional compartment 110 for light lifting gas (such as hydrogen or helium), a compartment 112 for the transported gas and a compartment 113 for air. Compartments 112 and 113 in the described embodiment have a shared wall in a form of a flexible or foldable membrane. The envelope skin serves as another wall of compartments 110, 112 and 113. The pressure in compartments 110, 112 and 113 equals or slightly exceeds the outside air pressure. There is a probe 114 for loading/unloading the transported gas and other carried fluids. Probe 114 is connected by a pipe or hose 115 to transported gas compartment 112. There is a vessel 116 for additional fluid cargo. In this embodiment, such additional fluid cargo is the same transported gas in a compressed or liquefied form. This allows to transport more gas, while also using this compressed or liquefied gas as a ballast. Vessel 116 is designed to withstand pressure of the compressed or liquefied gas, carried in it. It might be also thermo-insulated. A means 117 for moving the transported gas from compartment 112 to vessel 116, including a compressor, may be provided. There may be means for moving the gas from vessel 116 to compartment 112, including a valve. Moving the natural gas from compartment 112 to vessel 116 and back in flight can be used to decrease or increase volume of compartment 112 and, thus, buoyancy of the airship. There might be provided means for cooling vessel 116 by decompressing or evaporating its content, while moving it from vessel 116 to compartment 112. These just mentioned means, if provided, contain a pipe or hose 119 between vessel 116 and compartment 112. A pipe or hose 118 connect vessel 116 to probe 114, allowing loading/unloading of the fluid into / out of vessel 116. The airship is equipped with an electronic control system 120. There is also a valve 121, letting outside air in and out of compartment 113 as necessary.

FIG. 1B and FIG. 1C illustrate the operation of the system, when the natural gas is being transported. In FIG. 1 B, the airship is loaded with the natural gas, and the transported gas compartment 112 occupies most of the internal space of the airship. Compartment 113 has relatively small volume. When the airship's altitude increases and outside pressure decreases, transported gas compartment 112 expands even further at the expense of air compartment 113. In FIG. 1 C, the airship is “unloaded”, and most of its internal space is occupied by air in compartment 113. Vessel 116 is empty or near empty. In this configuration the airship travels back after unloading the natural gas. In this preferable embodiment, the buoyancy of light gas compartment 110 compensates the mass of the airship, including vessel 116. The volume of light gas compartment remains the same in both loaded and unloaded states.

There may be plurality of any or each of compartments 110, 112 and/or 113 within the airship. Compartments 113 can be made as ballonets and serve the same function. In more embodiments, any of compartments 111, 112 and 113 can be bags. If all compartments 111, 112 and 113 are bags, envelope 101 does not have to be gas tight. One or multiple vessels 116 can be carried inside or outside of envelope 101. Vessels 116 can be rigid or flexible. Multiple vessels 116 may be distributed along the lower part of envelope 101 to spread their weight. To accommodate various compositions of natural gas and outside temperature, the volume of light gas compartment 110 may be changed occasionally (for example, in maintenance), but such change is not required on each delivery.

Vessels 116 carry useful cargo fluid, which also serves as a ballast. Fluid is gas or liquid. In the case of natural gas transportation, this ballast fluid may be additional amount of the natural gas, carried as compressed natural gas (CNG) or liquefied natural gas (LNG). Which one is economically preferable, depends on specific case. When transporting gas from wells to pipeline stations or other consumers, CNG seems more economical in most climates. LNG may be more economical in very cold areas, like those with air temperature below −25° C. It should be noted, that even in CNG some fractions may be in a liquid phase. When intended to carry CNG, vessel 116 should be preferably made of strong light materials (for example, carbon fiber, vectran or E-glass).

Besides CNG and LNG, vessel 116 can carry other fluids, such as liquid petroleum gases (LPG), oil, compressed carbon dioxide or even water. For example, when carrying flare gas from an oil well, vessel 116 may be filled with oil, which is unloaded at the destination. If there are multiple vessels 116, they may carry different fluids. When water is available at the loading station, vessel 116 can be filled with the water. At the unloading station, the water is unloaded as another fluid, and then either used or accurately disposed of. At low temperature, the water may be heated to prevent freezing. The advantage of water and oil is that vessel 116 does not have to withstand pressure when it is designed to contain water or oil.

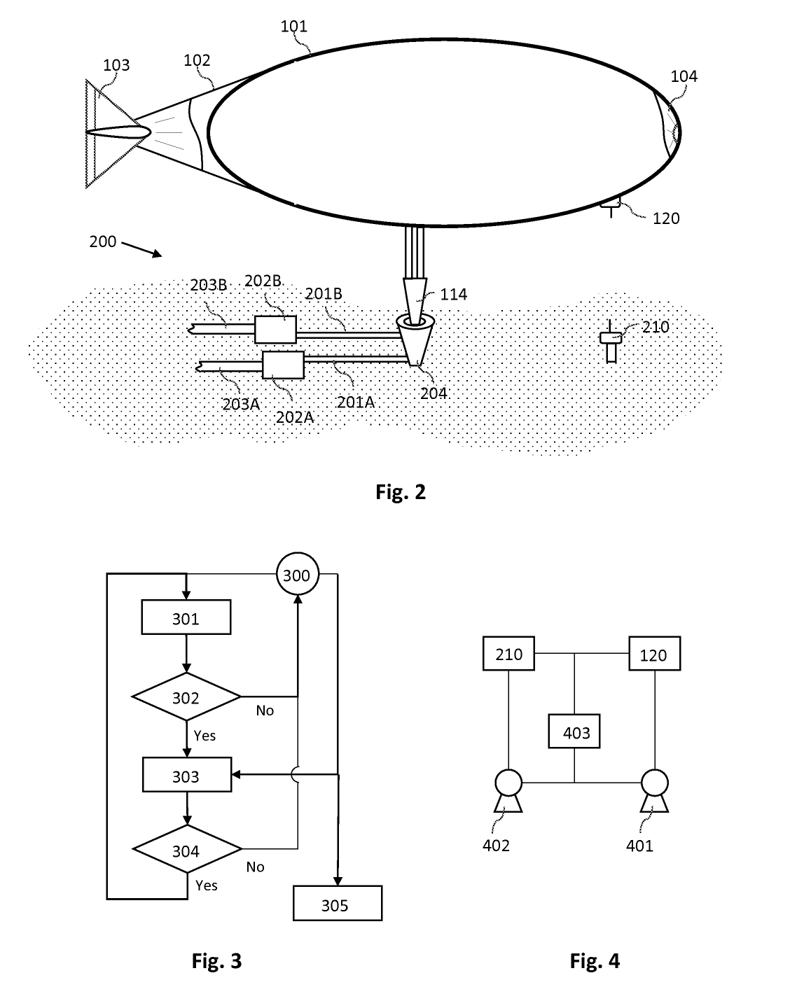

FIG. 2 shows the airship, connected to a loading or unloading station 200. Station 200 comprises a receiver 204 with internal pipes for the natural gas and the cargo fluid, matching the pipes in probe 114. Connected to the internal pipes, there is an outside pipe 201 A for the transported gas and at least one outside pipe 201 B for the cargo fluid. Pipe 201A is connected to pumping means 202A, such as a gas compressor or a valve, with possible heat exchanger. Pumping means 202A is connected to a reservoir or pipeline 203A. Pipe 201 B is connected to pumping means 202B. Depending on the cargo fluid, means 202B can comprise a compressor, a heat exchanger, a turbo-expander, valves, a liquefier or an evaporator. Pumping means 202B is connected to a reservoir or pipeline 203B. In case when natural gas is carried both in compartment 112 and in vessel 116, 203A and 203B can be the same gas storage or pipeline. Generally speaking, pumping means 202A in a loading station is different than pumping means 202A in an unloading station, and the same is true regarding pumping means 202B. There is a ground control system 210, used to control the ground equipment and to assist the airships in navigation and/or docking. Ground control system 210 can be completely automatic, or include a man in the loop, or to be manual. In most cases, station 200 contains only loading or only unloading equipment.

FIG. 3 illustrates one aspect of the airship operation in this embodiment. In the beginning, the airship is under remote manual control (state 300). The airship flies to the load source and attempts to receive the load of the gas and cargo fluid (state 301). The airship's control system continuously monitors the operations and clears errors, if possible. Referring a decision step 302, if the loading was successful, the airship flies to the load destination and attempts to unload the gas and cargo fluid (state 303). Referring a decision step 304, if the unloading was successful, the airship enters state 301 again and so on. On error in decision step 302 or 304, the airship requests manual control, entering state 300. The operator on the ground can then direct airship into a special troubleshooting state 305, or resolve the problem remotely and order the airship back into state 301 or state 303. The operator can override the system and take over control any time.

FIG. 4 illustrates the most important communication channels between airship control system 120, individual station control system 210, a global operational control system 403, an airships operator 401 and an optional ground station operator 402.

In an example of loading operation, the airship arrives to a gas field “empty”: air compartment 113 occupies most of its internal space and vessel 116 is not filled (as shown in FIG. 1 C). The natural gas comes from the gas storage on the ground, where it may be under pressure of 30 bar, for example. Through pipe 201 B, the compressed gas fills in vessel 116. Simultaneously, another stream of the gas from the same storage is decompressed and heated to ambient temperature inside of pumping means 202A, passes through pipe 201A and fills in compartment 112. As compartment 112 inflates, air exits compartment 113 through valve 121. The rate of gas supply through pipes 201A and 201 B is regulated to maintain constant buoyancy. In the end of the loading operation, compartment 112 occupies most of the internal space of the airship and vessel 116 contains appropriate amount of the compressed gas (as shown in FIG. 1 B).

An unloading operation occurs in reverse. The loaded airship arrives to a pipeline station. The natural gas is pumped from compartment 112 and vessel 116 simultaneously. An additional small compressor (possibly carried by the airship) pumps outside air into compartment 113 to prevent deflation and/or collapse of the airship. In the end of the unloading, the airship reverts to configuration shown in FIG. 1 C. Preferably, the internal volume of the airship does not change significantly in the loading and unloading operations.

In a typical scenario, the airship will shuttle between a loading source (such as a gas wellhead or an oil platform with flare gas) and an unloading destination (such as a pipeline inlet station) in a closed loop. The route can be fully pre-defined, including altitudes, or can be changed dynamically, to take advantage of the winds at different altitudes. The airship uses GPS or other navigational means for navigation. In the vicinity of the ground station the airship descends and uses a video camera and/or wireless triangulation to get into an exact position above receiver 204. Preferably, the airship comes upwind. Staying few meters above receiver 204, the airship drops probe 114 into receiver 204. When the connection is secured, the loading or unloading operation starts. The airship uses thrust vectoring of engines 105 and/or additional small maneuvering engines or thrusters to stay in one place, despite the winds. In some cases, it might be preferable to design probe 114 and receiver 204 to allow the airship to rotate around the receiver vertical axis to stay with its bow into the wind. Airship can be equipped with a laser anemometer to anticipate changes in a wind and to rotate actively, when the wind changes. The airship does not need to land. After finishing the loading or unloading operation, the airship pools in probe 114, ascends and flies back. To quickly ascend or descend in flight, the airship may change its attitude by appropriate movement of the horizontal rudders and/or thrust vectoring. The airship may be equipped with wings, having airfoil section of conventional, symmetrical or conventional upside down shape.

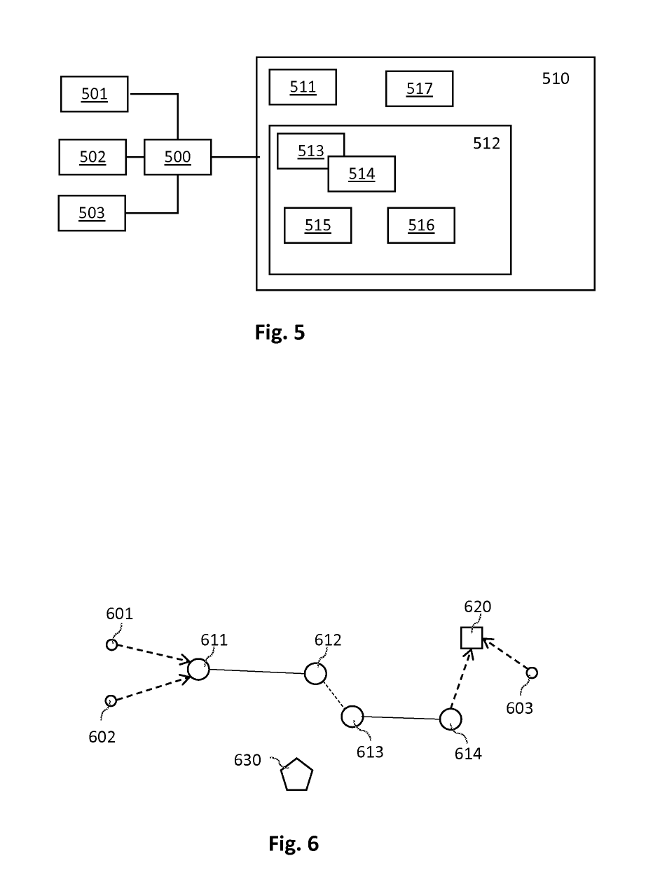

As shown in FIG. 5, airship control system 120 may comprise a central processing unit 500, communications means 501 (for radio, cellular or satellite communication), navigation means 502, route programming means 503 and a docking subsystem 510. Navigation means 502 may comprise usual avionics, used on civilian aircrafts, airships and UAVs, including GPS, LORAN, day and night cameras, an altimeter, a radar etc. Route programming means 503 should be capable to receive pre-programmed routes or to compute routes dynamically based on coordinates or radio signal of the destination. Preferably, the airship flies autonomously, but monitored by experienced pilots from the ground, who can take over the control remotely. Docking subsystem 510 may comprise a control unit 511, connected to sensors/networking suite 512, possibly including a local short range wireless networking means 513 (some examples of wireless protocols are Wi-Fi, Bluetooth and WiMAX), having a wireless triangulation module 514, optical means 515 (some examples of which are day and/or night cameras, a laser rangefinder, spotlights) and short range communication means 516 for communication with ground control system 210. Using sensors 512, control unit 511 steers the airship to the preferred spot and performs docking. There are navigation aids on the ground, considered a part of ground control system 210.

The navigation aids on the ground may include a radio antenna, a wireless router or endpoint, wireless “beacons” for triangulation, night lights, geometric patterns on the ground etc. Sensors similar to those from sensors suite 512 may be installed on the ground as a part of ground control system 210. In this case, ground control system 210 processes the data and issues commands to control system 120 of the airship, which receives and executes them using a command execution block 517. In this case, the airship may be able to carry fewer sensors.

FIG. 6 shows an example of a natural gas transportation network, utilizing the airship and loading/unloading stations described above. The airship routes are shown in dashed lines. Natural gas, extracted at wellheads 601 and 602 is delivered by the airships to a pipeline inlet station 611, and then transported by the pipeline network (shown in solid lines). If desirable, two disconnected pipeline networks can be joined by airships routes, as between stations 612 and 613. Airship routes can be also used for delivery of natural gas from large pipelines or wellheads to large users, such as power plants, gas liquefaction terminals or synthetic fuel plants. In FIG. 6, a power plant 620 receives gas by airships from both a wellhead 603 and a pipeline terminal 614. The inlet stations can be equipped to perform the natural gas processing, eliminating most of the processing needs at the wellheads. The network of the airships and loading and unloading stations is monitored and controlled by a monitoring or control station 630.

The network and the airships can operate continuously 24×7. Multiple airships can work one route, or a single airship can work multiple routes. Unlike trucks or railway cars, the airships do not need roads or railways. Unlike pipelines, the airships are totally flexible and can easily switch from one route to another, possibly through a simple operation of uploading new route data and appropriate commands. The natural gas can be transferred almost straight from the wellhead, eliminating most processing. If the natural gas is associated with oil or has large amount of LPG, some of the oil or LPG can be carried by the airship as well. The natural gas can also be transferred from pipeline terminals to remote areas, such as shale or bitumen retorting plants. Since the airship does not carry humans on board, it should not be subject to high safety requirements, which drive up the costs of the conventional aviation. The natural gas in the airship is not a significant fire hazard. It is less flammable than hydrogen (the danger of which is also widely exaggerated based on incidents from the early period of the previous century, when goat skin was used for hydrogen bags).

Nevertheless, the airship routes should be preferably selected far from large population centers, minimizing potential damage from possible airship crashes. The airship does not require a hangar, because it is continuously flying. A single maintenance hangar can be time shared by multiple airships. In case of dangerous weather (like a thunderstorm) the airship can be simply flown away by a command from monitoring station 630. In some embodiments of the invention, an airship can be designed for specific gas fields and routes and even seasons of a year.

The described system allows economic transportation of the natural gas or another methane containing gas where it was impossible before:
exploitation of stranded and flare gas sources by transporting the natural gas from wellheads to existing pipelines or other gas facilities;
exploitation of offshore gas fields by transporting the natural gas from the offshore platform to existing pipelines onshore;
delivery of gas to remote customers, including bitumen and/or kerogen processing facilities;
emergency delivery of gas (and possibly other materials or goods) to disaster areas;
transportation of gas over geographically inaccessible or politically unstable areas;
transportation of gas in countries or areas without pipeline infrastructure;
temporary or permanent joining of disconnected pipeline networks;
delivery of gas to/from LNG terminals;
replacement for the LNG terminals and ships.

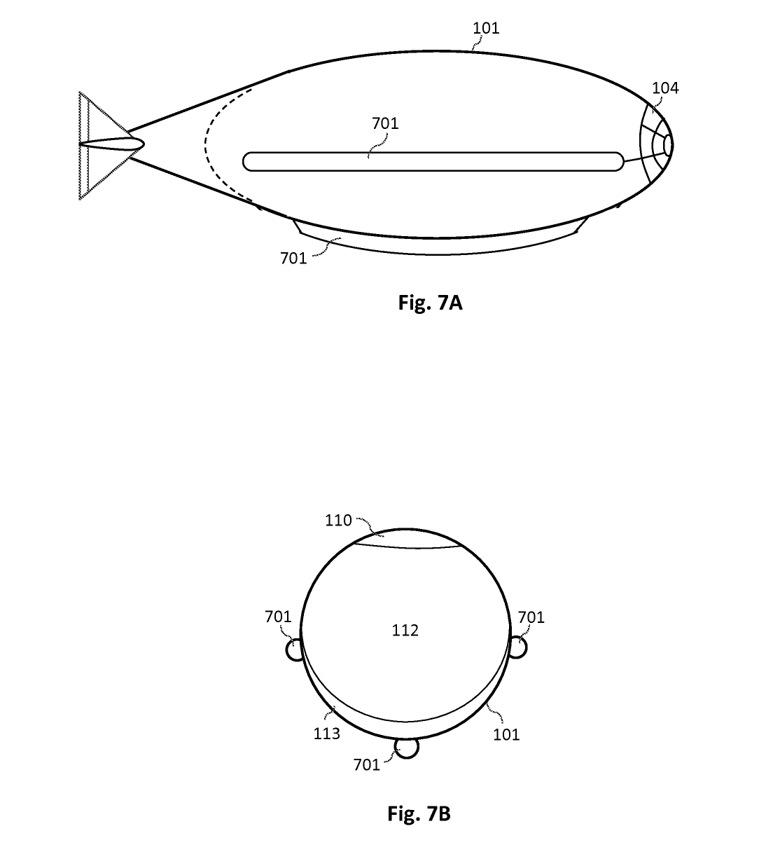

The airship can be rigid, semi-rigid or non-rigid. Pressure vessel 116 can be a part of the airship framework. Another possibility is to implement vessels 116 as flexible elongated containers (similar to hoses with closed ends). FIG. 7A and FIG. 7B show another embodiment, in which the airship is non-rigid (a blimp) and three flexible elongated containers 701 are designed for cargo/ballast fluid. Containers 701 are connected to bow 104 and provide some degree of stiffness to the airship.

The described system and method are applicable not only to transportation of natural gas, but other gases as well, both lighter and heavier than air. In general, the closer the density of the transported gas to the density of the air, the more efficient the system can be. Multiple variations on the structures and methods, described above, are possible. For example, compartments 112 and 113 can be placed inside one another. Separate compartment 110 can be omitted when transporting lighter than air gases (in which case, larger amount of the transported gas would remain inside the airship when it returns “empty”). The airship may be towed by another aircraft, including another airship, a plane or a rotorcraft. In other embodiments, the airship may dock by its bow instead of its “belly”, use separate connections for transfer of the transported gas and the cargo fluid etc. With certain modifications, some systems described above can be used for gas distribution (not only transportation) in countries or areas, lacking pipeline infrastructure. The modifications would allow unloading small amounts of the gas, using minimum ground infrastructure.

In another embodiment, instead of vessel 116, the airship carries a vessel with liquid ammonia (or dimethyl ether or another easily liquefied gas). There is also another collapsible compartment for this ammonia in an evaporated state. When the airship is loaded with natural gas, the ammonia is liquefied and stored in its vessel. When the airship unloads the natural gas, the ammonia is evaporated, and fills up its compartment, thus providing necessary buoyancy.

In yet another embodiment, the envelope of the airship is thermally insulated. The natural gas is pre-cooled prior to filling its compartment (which is easy to achieve because natural gas is usually stored and processed under pressure, and it cools down when decompressed to atmospheric pressure). Thus, the density of the cooled natural gas is equalized with the density of the ambient air. This low temperature is maintained in the flight using a refrigerator, possibly driven by an on-board engine, using the carried gas as the fuel. Relative air flow around the airship or slipstream from the airship props or funs may be used for efficient cooling of the working fluid of the refrigerator. After unloading the natural gas, the air compartment is filled with the air at the ambient temperature. Vessel 116 becomes unnecessary in this embodiment.

In one more embodiment with the thermally insulated envelope, the air compartment of the airship is filled with steam or hot air or their mix when the natural gas is unloaded. Thus, buoyancy of the airship remains the same. The elevated temperature inside is maintained in the flight by passing through it exhaust from the airship main engines. This embodiment may be efficiently combined with the previous one (i.e., buoyancy equalization is achieved in part by cooling the natural gas when the airship is loaded, and partially by heating air or using steam on the way back).

Thus, a system and a method for gas transportation by air is described in conjunction with one or more specific embodiments. While above description contains many specificities, these should not be construed as limitations on the scope, but rather as exemplification of several embodiments thereof. Many other variations are possible.

What is claimed is:

1. A method of transporting a lighter than air gas, the method comprising:
providing an unmanned steerable airship, comprising an envelope, a propulsion means and an automatic control system, having a plurality of sensors and a plurality of microprocessors;
at a first location, loading the transported gas into the envelope of the airship;
flying the airship from the first location to a second location, using the automatic control system;
at the second location, unloading at least most of the transported gas from the airship.

2. The method of claim 1, further comprising:
at the first location, additionally loading a cargo fluid onto the airship;
at the second location, unloading the cargo fluid from the airship.

3. The method of claim 1, wherein the airship permanently carries a predefined amount of hydrogen or helium.

4. The method of claims 1, wherein the transported gas provides at least half of the buoyancy of the airship when the airship flies from the first location to the second location.

5. The method of claim 1, wherein the transported gas is natural gas.

6. The method of claim 5, wherein the cargo fluid contains an additional amount of the natural gas under above atmospheric pressure.

7. The method of claim 6, wherein the additional amount of the transported gas is under pressure of at least 10 bar.

8. The method of claim 5, wherein the cargo fluid contains an additional amount of the natural gas in liquid form.

9. The method of claim 5, wherein the cargo fluid contains liquid hydrocarbons, selected from the group consisting of ethane, propane, butane and pentane.

10. The method of claim 5, wherein the cargo fluid is water.

11. An airship for transporting gas, the airship comprising:
an envelope;
a propulsion means;
an automatic control system for unmanned flight, the automatic control system having a plurality of sensors, a plurality of microprocessors;
a first variable volume compartment within the envelope for the transported gas;
a second variable volume compartment within the envelope for air;
a vessel for a fluid which serves as a ballast;
wherein at least half of the vehicle buoyancy is created by the transported gas.

12. The airship of claim 11, further comprising a fixed volume compartment for helium or hydrogen.

13. The airship of claim 11, wherein the transported gas is natural gas.

14. The airship of claim 11, wherein the first variable volume compartment is a bag.

15. The airship of claim 11, wherein the second variable volume compartment is a bag.

16. The airship of claim 11, wherein the vessel is a pressure vessel, capable of withstanding internal pressure substantially above the atmospheric pressure.

17. The airship of claim 11, wherein the vessel contains the transported gas, compressed substantially above the atmospheric pressure.

18. The airship of claim 17, further comprising a compressor, adapted to compress some of the transported gas from the first variable volume compartment and to move it into the vessel.

19. The airship of claim 11, wherein the vessel contains hydrocarbon fluids at above atmospheric pressure and at least some of the hydrocarbon fluids are in liquid phase.

20. The airship of claim 11, wherein the vessel is adapted to be filled with liquid at normal temperature and pressure.

21. The airship of claim 11, wherein the vessel contains liquid hydrocarbons.

22. The airship of claim 11, wherein the vessel contains water.

23. The airship of claim 11, further comprising a probe for transfer of the transported gas between the airship and ground installations.
